(19) United States
(12) Patent Application Publication
(10) Pub. No.: US 2006/0197684 A1
(43) Pub. Date: Sep. 7, 2006

(54) Programmable traffic light unit

(76) Inventor: Jacques Tremblay, St. Alexandre (CA)

Correspondence Address: GREENBERG TRAURIG, LLP, 77 WEST WACKER DRIVE, SUITE 2500, CHICAGO, IL, 60601-1732, US

(21) Appl. No.: 11/063,765

(22) Filed: Feb. 23, 2005

(51) Int. Cl. G08G 1/08; G08G 1/096

(52) U.S. Cl. 340/909; 340/929

(57) ABSTRACT

A programmable traffic light unit includes traffic signal means for producing a traffic signal, a signal control input for receiving a control signal from an intersection traffic controller, and a logic module coupled to the traffic signal means and the signal control input. The control signal is configured to control the timing of the traffic signal. The logic module is configured to control the traffic signal, and is also configured to configure the traffic signal from a programming command received over the signal control input.

### FIELD OF THE INVENTION

The present invention relates to a traffic light unit. In particular, the present invention relates to a mechanism for configuring a traffic light unit after manufacture and deployment at an intersection.

### BACKGROUND OF THE INVENTION

The conventional traffic light unit includes a traffic signal device, and may include a countdown signal device fixed to the traffic signal device. The traffic signal device produces a vehicular traffic signal comprising a red light, green light or amber light for controlling vehicular traffic. Alternately, the traffic light unit may include a pedestrian signal device, and a countdown signal device fixed to the pedestrian signal device. The pedestrian signal device produces a pedestrian traffic signal comprising a “walk” pictogram or a “don't walk” pictogram for controlling pedestrian traffic. The countdown signal device includes a countdown display that indicates the time remaining before a change in the status of the pedestrian traffic signal (or the vehicular traffic signal, if fixed to the traffic signal device).

The conventional traffic light unit includes a traffic signal device, and may include a countdown signal device fixed to the traffic signal device. The traffic signal device produces a vehicular traffic signal comprising a red light, green light or amber light for controlling vehicular traffic. Alternately, the traffic light unit may include a pedestrian signal device, and a countdown signal device fixed to the pedestrian signal device. The pedestrian signal device produces a pedestrian traffic signal comprising a “walk” pictogram or a “don't walk” pictogram for controlling pedestrian traffic. The countdown signal device includes a countdown display that indicates the time remaining before a change in the status of the pedestrian traffic signal (or the vehicular traffic signal, if fixed to the traffic signal device).

Typically, several traffic light units are deployed at a traffic intersection, with each traffic light unit being controlled by an intersection traffic controller deployed at the intersection. The intersection traffic controller includes traffic sensor inputs for sensing the movement of traffic at the intersection, and produces control signals for controlling the timing of the traffic signals at the traffic light units. Each traffic light unit includes signal control inputs for receiving the control signals from the intersection traffic controller. Typically, the pulse width and voltage levels of the signal control output signals determines the timing and duration of the traffic signals.

The time allowed for a pedestrian to cross the intersection (“pedestrian cycle”) is determined by various parameters, such as the size of the intersection. The pedestrian cycle includes a period (“walk time”) during which the pedestrian is instructed that it is safe to enter the intersection (typically via a solid “walk” pictogram), and a period (“clearance time”) during which the pedestrian is instructed to clear the intersection (typically via a flashing “don't walk” pictogram). The length of the pedestrian cycle, the walk time and the clearance time are programmed into the intersection traffic controller at the time of installation.

A significant problem with the conventional traffic light unit is that the functionality required of the traffic signal device, the pedestrian signal device and/or the countdown signal device is under governmental control. Since the traffic light unit is exposed to the elements, it must be sealed to prevent deterioration of the sensitive electronics disposed within its housing. Accordingly, typically the traffic light unit must be replaced if the functional requirements change after the traffic light unit is manufactured and put into use.

Further, different governments may impose different functionality requirements, thereby requiring the manufacture to maintain different electronics circuitry for the different jurisdictions in which the traffic light units will be used. Accordingly, attempts have been made to develop a traffic light unit having enhanced functionality.

For instance, GelCore LLC (WO 2004/070675) described an intelligent traffic signal device having four dedicated command inputs: on/off, dimming, flashing and emergency disconnect. The dimming command input dims the light output of the traffic signal device to a predetermined level. The flashing command input puts the traffic signal device into a flashing mode. Although these command inputs allow the functionality of the traffic signal device to be modified somewhat after manufacture, the provision of the command inputs increases the risk that the electronics disposed within the traffic signal display may become exposed to the elements. Further, the provision of the command inputs increases the risk of the functionality of the traffic signal device becoming exposed to unauthorized tampering.

Therefore, there remains a need for a traffic light unit having enhanced functionality.

### SUMMARY OF THE INVENTION

In accordance with a first aspect of the present invention, there is provided a traffic light unit that can be programmed via the signal control inputs over which the traffic light unit would normally receive control signals from an intersection traffic controller.

The traffic light unit includes traffic signal means for producing a traffic signal, a signal control input for receiving a control signal from an intersection traffic controller, and a logic module coupled to the traffic signal means and the signal control input. The control signal determines the timing of the traffic signal. The logic module is configured to control the traffic signal, and is also configured to configure the traffic signal from a programming command received over the signal control input.

The traffic light unit may be implemented as a vehicular traffic signal device for controlling the movement of vehicular traffic through an intersection, a pedestrian traffic signal device for controlling the movement of pedestrian traffic through an intersection, and/or a countdown signal device for indicating the time remaining for clearing an intersection.

The traffic signal (as produced by the traffic signal means) may comprise a vehicular traffic signal (as produced by a vehicular traffic signal device), a pedestrian traffic signal (as produced by a pedestrian traffic signal device) and/or a countdown signal (as produced by a countdown signal device). The traffic signal may be a visual signal, an audible signal or any suitable signal for controlling vehicular and/or pedestrian traffic.

The traffic signal means may comprise a traffic display for controlling the vehicular and/or pedestrian traffic, and/or a countdown display for indicating the time remaining for clearing the intersection.

In one implementation, the logic module is configured to recognize a programming command during a power-up interval of the traffic light unit, and to ignore the programming command after the power-up interval. Further, the logic module is configured to ignore the control signal during the power-up interval, and to recognize the control signal after the power-up interval.

Preferably, the logic module is configured to recognize one or more of the following programming commands: global time, walk count display, countdown maintain, flashing walk, time variation, lamp brightness, and brightness mode. The logic module may be configured to implement other programming commands.

The global time command requires the logic module (i) to begin counting down at the countdown display at the start of the pedestrian cycle and to continue counting throughout the pedestrian period, or (ii) to begin counting down at the start of the walk period, and to begin counting again at the start of the clearance period.

The walk count display command requires the logic module (i) to display the count value during the walk period and the clearance period, or (ii) to display the count value only during the clearance period.

The countdown maintain command requires the logic module to maintain or remove the time indication at the countdown display at the end of a clearance period.

The flashing walk command configures the logic module (i) to treat a “flashing walk” signal at the pedestrian signal device as a clearance signal, or (ii) to treat a “flashing hand” signal at the pedestrian signal device as a clearance signal.

The time variation command requires the logic module to ignore or recognize an incremental change in the duration of the pedestrian cycle.

The lamp brightness command requires the logic module to set the brightness of the traffic signal to the value determined by the lamp brightness command.

The brightness mode command requires the logic module to (i) set the brightness of the traffic signal to a maximum value, or (ii) to use a photocell to automatically adjust the brightness of the traffic signal based on a measure of the ambient light at the traffic light unit.

In accordance with a second aspect of the present invention, there is provided a traffic light programmer that can program a traffic light unit over the signal control inputs of the traffic light unit.

The traffic light unit programmer includes a traffic signal output for interfacing with a signal control input of a traffic light unit, and a program module coupled to the traffic signal output. The traffic light unit includes means for producing a traffic signal. The signal control input is configured to receive a control signal from an intersection traffic controller for controlling the timing of the traffic signal. The program module is configured to transmit a programming command to the traffic light unit for implementing a configuration of the traffic signal.

In accordance with a third aspect of the present invention, there is provided a method of programming a traffic light unit (where the traffic light unit comprises traffic signal means for producing a traffic signal and a signal control input for receiving a control signal from an intersection traffic controller, with the control signal being configured to control a timing of the traffic signal). The programming method involves the steps of (1) directing the traffic light unit into a programming mode; (2) transmitting a program command to the traffic light unit via the signal control input; and (3) directing the traffic light unit into a normal operational mode.

In accordance with a fourth aspect of the present invention, there is provided a computer-readable medium carrying processing instructions for a computer which, when executed, cause the computer to perform a method of programming a traffic light unit. The traffic light unit comprises traffic signal means for producing a traffic signal and a signal control input for receiving a control signal from an intersection traffic controller, with the control signal being configured to control a timing of the traffic signal. The programming method involves transmitting a program command to the traffic light unit via the signal control input.

Since the traffic light unit is able to be configured via the same signal control inputs over which it receives control signals from the intersection traffic controller, no additional apertures need to formed in the housing of the traffic light unit. Also, should the required configuration of the traffic signal change after the traffic light unit is manufactured, the configuration of the traffic signal produced by the traffic light unit can be quickly updated. Further, since all the traffic light units at an intersection are connected to the same intersection traffic controller, the configuration of the traffic signals produced by all the traffic light units at the intersection can be updated from a single location.

### BRIEF DESCRIPTION OF THE DRAWINGS

The present invention will now be described, by way of example only, with reference to the accompanying drawings, in which:

FIG. 1 is a schematic view of a traffic control system according to the present invention, depicting several traffic light units electrically connected to a common intersection traffic controller;

FIG. 2 is a front plan view of one of the traffic light units shown in FIG. 1, depicting a traffic signal device and associated countdown signal device;

FIG. 3 is a front plan view of another one of the pedestrian traffic light units shown in FIG. 1, depicting a pedestrian signal device and associated countdown signal device;

FIG. 4 is a schematic view of the countdown signal device shown in FIGS. 2 and 3, depicting the signal control input, and the logic module;

FIG. 5 depicts exemplary man logic signals and hand logic signals received by the countdown signal device when the countdown signal device is in the normal operational mode;

FIG. 6 depicts exemplary man logic signals and hand logic signals received by the countdown signal device when the countdown signal device is in the programming mode; and

FIG. 7 is a schematic view of a traffic light unit programmer which generates the programming signals for programming the countdown signal device.

### DETAILED DESCRIPTION OF THE PREFERRED EMBODIMENT

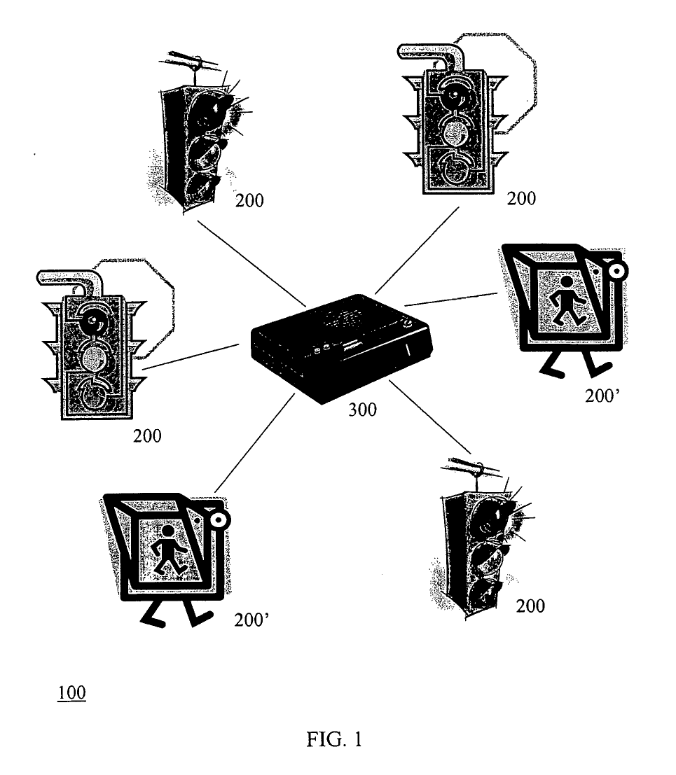

Turning now to FIG. 1, a traffic control system, denoted generally as 100, is shown comprising one or more traffic light units 200 electrically connected to a common intersection traffic controller 300. The traffic light units 200 and the intersection traffic controller 300 are deployed at a common traffic intersection. The intersection traffic controller 300 controls the vehicular and pedestrian traffic through the intersection by controlling the traffic signals produced by the associated traffic light units 200. The traffic signals may be visual signals, audible signals or any other suitable signal for controlling the vehicular and/or pedestrian traffic.

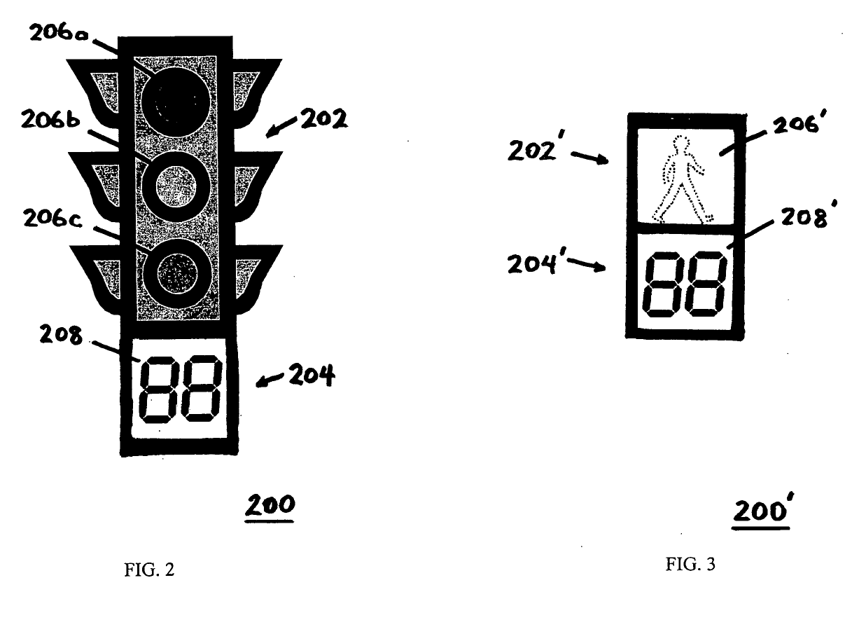

One embodiment of the traffic light unit 200 is depicted in FIG. 2. As shown, the traffic light unit 200 includes a traffic signal device 202, and a countdown signal device 204 fixed to the traffic light module 202. Preferably, the traffic signal device 202 includes a vehicular traffic display 206 that produces a visual vehicular traffic signal for controlling vehicular traffic. Further, preferably the vehicular traffic signal is produced by the timed illumination of a red lamp 206a, an amber lamp 206b and a green lamp 206c.

Other configurations of the vehicular traffic signal are intended to be encompassed by the present invention. For instance, the vehicular traffic signal need not be produced by three distinct colours, or three separate lights. Further, the vehicular traffic signal need not consist only of visual means for controlling vehicular traffic, but may include other suitable vehicular traffic signal means, such as audible means or a combination of audible and visual means.

The countdown signal device 204 includes a countdown display 208 that provides a numerical countdown signal indicating the time remaining before a change in the status of the vehicular traffic signal and/or the time remaining to clear the intersection. Typically, the countdown display 208 comprises a tens digit, and a ones digit. Further, typically the vehicular traffic signal and the countdown signal are implemented with light-emitting diodes (LEDs).

Other configurations of the countdown signal provided by the countdown signal device 204 are intended to be encompassed by the present invention. For instance, the countdown signal need not use only a numerical count to indicate the time remaining before a change in the status of the vehicular and/or pedestrian traffic signal. Also, the countdown signal need not consist only of visual means for controlling pedestrian traffic, but may include other suitable countdown signal means, such as audible means or a combination of audible and visual means.

Another embodiment of the traffic light unit is depicted in FIG. 3. As shown, the traffic light unit 200′ includes a pedestrian signal device 202′, and a countdown signal device 204′ fixed to the pedestrian signal device 202′. Preferably, the pedestrian signal device 202′ includes a pedestrian traffic display 206′ that produces a visual pedestrian traffic signal for controlling pedestrian traffic. Further, preferably the pedestrian traffic signal is produced by a red “walk” pictogram, and a green “don't walk” pictogram.

Similarly, other configurations of the pedestrian traffic signal are intended to be encompassed by the present invention. For instance, the pedestrian traffic signal need not comprise distinct colours. The pedestrian traffic signal need not comprise pictograms, but instead may comprises other means for indicating the walk time and the clearance time of the pedestrian cycle. Also, the pedestrian traffic signal need not consist only of visual means for controlling pedestrian traffic, but may include other suitable pedestrian traffic signal means, such as audible means or a combination of audible and visual means.

The countdown signal device 204′ includes a countdown display 208′ that provides a numerical countdown signal indicating the time remaining before a change in the status of the pedestrian traffic signal and/or the time remaining to clear the intersection. Typically, the pedestrian traffic signal and the countdown signal are implemented with LEDs.

Other configurations of the countdown signal provided by the countdown signal device 204′ are intended to be encompassed by the present invention. For instance, the countdown signal need not use only a numerical count to indicate the time remaining before a change in the status of the vehicular and/or pedestrian traffic signal. Also, the countdown signal need not consist only of visual means for controlling pedestrian traffic, but may include other suitable countdown signal means, such as audible means or a combination of audible and visual means.

Hereafter, the phrase “traffic signal” will be used to refer to the vehicular traffic signal (as produced by the traffic signal device), the pedestrian traffic signal (as produced by the pedestrian signal device), and/or the countdown signal (as produced by the countdown signal device). Also, the phrase “traffic signal means” will be used to refer to the vehicular traffic display (as implemented for example in the traffic signal device), the pedestrian traffic display (as implemented for example in the pedestrian signal device), and/or the countdown display (as implemented for example in the countdown signal device).

The traffic signal device 202 and the pedestrian signal device 202′ are of conventional design. Accordingly a detailed description of the traffic signal device 202 and the pedestrian signal device 202′ is unnecessary.

Hereafter, reference numeral 200 will be used to represent both embodiments of the traffic light unit. Also, reference numerals 202 and 204 will be used hereafter to respectively represent both implementations (traffic and pedestrian) of the signal device and both implementations of the countdown signal device. Further, reference numerals 206 and 208 will be used hereafter to respectively represent both implementations (eg. vehicular traffic display 206, pedestrian traffic display 206′) of the traffic signal means and both implementations (eg. countdown display 208, countdown display 208′) of the countdown display.

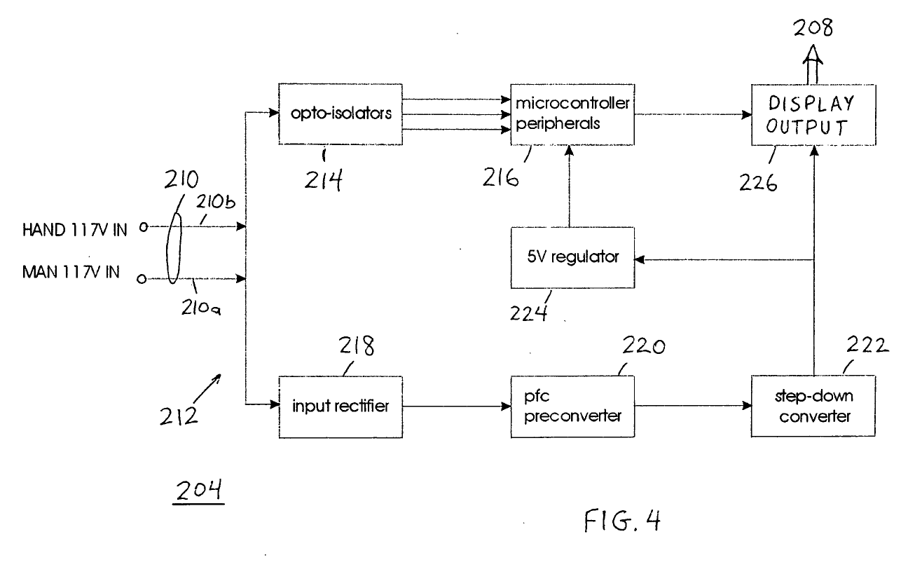

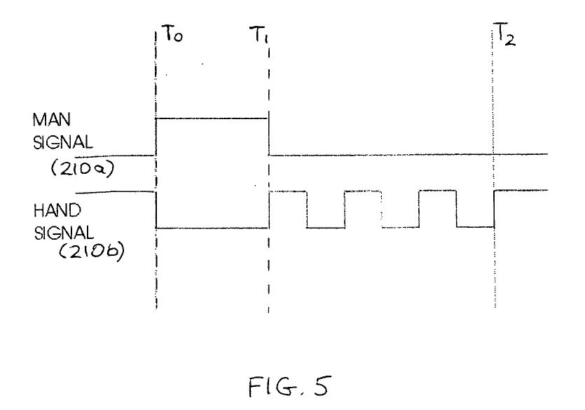

FIG. 4 depicts an embodiment of the countdown signal device 204. As shown, the countdown signal device 204 includes a signal control input 210 for receiving a control signal from the intersection traffic controller 300, and a logic module 212 coupled to the signal control input 210. The signal control input 210 includes a man (walk) input 210a, and a hand (don't walk) input 210b. Optionally, the signal control input 210 includes an auxiliary input (not shown) which can be used by the logic module 212 for added functionality.

The logic module 212 comprises an opto-isolator section 214 coupled to the signal control input 210, a microcontroller 216 coupled to the output of the opto-isolator section 214, a power rectifier section 218 coupled to the signal control input 210, a power-factor converter section 220 coupled to the output of the power rectifier section 218, a DC/DC step-down converter section 222 coupled to the output of the power-factor converter section 220, a voltage regulator 224 coupled to the output of the step-down converter section 222, and a display output 226 coupled to the digital output of the microcontroller 216.

The signals received on the man input 210a and the hand input 210b are sinusoids, each approximately 117 Vrms. The opto-isolator section 214 isolates the microcontroller 216 from the signal control input 210, and converts the signals received at the signal control input 210 to logic levels that can be used by the microcontroller 216. The power rectifier section 218, the power-factor converter section 220 and the step-down converter section 222 together provide the DC voltage level necessary for powering the countdown display 208. The voltage regulator 224 provides the DC voltage level necessary for powering the microcontroller 216.

The display output 226 provides the drive current sufficient for driving the LED lamps of the countdown display 208. The display output 226 comprises a tens lamp driver for driving the tens digit LED array of the countdown display 208, and a ones lamp driver for driving the ones digit LED array of the countdown display 208.

The microcontroller 216 has an embedded non-volatile memory that includes computer processing instructions which when executed by the microcontroller 216 configures the logic module 212 to be able to control the traffic signals. In addition, the non-volatile memory includes computer processing instructions which when executed by the microcontroller 216 allows the logic module 212 to recognize a programming command received over the signal control input 210 and to configure the traffic signals based on the received programming command.

Other implementations of the logic module 212 are intended to be encompassed by the present invention. For instance, instead of implementing the logic module 212 with a microcontroller 216, the logic module 212 may be implemented with an application specific integrated circuit (ASIC).

Typically, the logic module 212 is in a normal operational mode during which the pulse width and voltage levels of the man signal (at the man input 210a) and the hand signal (at the hand input 210b) determines the timing and duration of the traffic signal (eg. as produced on the countdown display 208). Preferably, the logic module 212 is configured to only enter the programming mode if a valid programming command is received at the microcontroller 216 within a predetermined period upon power-up of the logic module 212. Thereafter (or if the programming command is invalid), the logic module 212 returns to the normal operational mode. Some proposed program options/commands and corresponding traffic signal configurations will be discussed below.

The intersection traffic controller 300 includes traffic sensor inputs for sensing the movement of traffic at the intersection, and produces control signals for controlling the timing of the traffic signals at the traffic signal units 200. Each traffic signal device 202, pedestrian signal device 202′, and countdown signal device 204 is connected to the intersection traffic controller 300 via its respective signal control input 210, and receives the control signals from the intersection traffic controller 300 at its respective signal control input 210. Typically, the pulse width and voltage levels of the control signals determines the timing and duration of the traffic signals produced by the traffic light units 200.

FIG. 5 depicts exemplary man logic signals and hand logic signals (received at the microcontroller 216 of the countdown signal device 204) when the countdown signal device 204 is in the normal operational mode. As discussed above, the actual signals received on the man input 210a and the hand input 210b are sinusoids, each approximately 117 Vrms. However, the opto-isolator section 214 converts these signals to the man logic signals and hand logic signals for use by the microcontroller 216.

The pedestrian signal device 202′ is connected electrically in parallel with the signal control input 210 of the countdown signal device 204 and, therefore, will receive the same logic signals as the pedestrian signal device 202′. Although the performance of the countdown signal device 204 will be discussed in association with the pedestrian signal device 202′, it should be understood that the countdown signal device 204 will perform in a similar manner when used in association with the traffic signal device 202.

Further, although the discussion so far has only described the logic module 212 as being implemented in the countdown signal device 204, it should be understood that the logic module 212 (and/or its functionality) may be implemented in the traffic signal devices 202 and/or the pedestrian signal devices 202′. Accordingly, the following discussion is also applicable to the traffic signal devices 202 and the pedestrian signal devices 202′ that have implemented the logic module 212 (and/or its functionality).

Initially, the intersection traffic controller 300 maintains the hand signal at a logic high level, and maintains the man signal at a logic low level. The pedestrian cycle begins (T0) when the intersection traffic controller 300 transitions the hand signal to the logic low level, and transitions the man signal to the logic high level. In response, the pedestrian signal device 202′ steadily illuminates the “walk” pictogram, thereby commencing the walk interval.

The walk interval terminates (T1) when the intersection traffic controller 300 transitions the man signal to the logic low level. At this point, the intersection traffic controller 300 begins to cycle the hand signal between the logic high and logic low levels at 1 Hz. In response, the pedestrian signal device 202′ may extinguish the “walk” pictogram, and flash the “don't walk” pictogram at 1 Hz., thereby commencing the clearance interval. However, other pedestrian traffic signals are possible. For instance, during the clearance interval, the pedestrian signal device 202′ may instead simply flash the “walk” pictogram.

The clearance interval terminates (T2) when the intersection traffic controller 300 maintains the hand signal at the logic high level. In response, the pedestrian signal device 202′ steadily illuminates the “don't walk” pictogram, thereby terminating the pedestrian cycle. The pedestrian cycle begins again when the when the intersection traffic controller 300 transitions the hand signal to a logic low level, and transitions the man signal to a logic high level,

As discussed above, the logic module 212 of the countdown signal device 204 is configured to control the traffic signals (eg. countdown signal). This aspect of the invention will now be explained.

During each pedestrian cycle, the microcontroller 216 maintains in an up-count register a walk counter that measures the elapsed time of the walk interval, and also maintains in a separate up-count register a clearance counter that measures the elapsed time of the clearance interval. At the start of the next pedestrian cycle (T0), the microcontroller 216 loads a down-count register with the value of the walk counter that was obtained from the previous pedestrian cycle. Depending upon the configuration of the pedestrian traffic signal that has been programmed into the countdown signal device 204, during the walk interval the logic module 212 will decrement the down-count register once per second, and will display the value of the down-count register on the countdown display 208.

At the end of the walk interval, the microcontroller 216 loads the down-count register with the value of the clearance counter that was obtained from the previous pedestrian cycle. Depending upon the configuration of the pedestrian traffic signal that has been programmed into the countdown signal device 204, during the clearance interval the logic module 212 may decrement the down-count register once per second, and may display the value of the down-count register on the countdown display 208.

Depending upon the configuration of the pedestrian traffic signal that has been programmed into the countdown signal device 204, at the end of the clearance interval the logic module 212 may maintain the value (zero) of the down-count register on the countdown display 208.

As discussed above, the logic module 212 of the countdown signal device 204 is also configured to configure the traffic signal (eg. countdown signal) from a programming command received over the signal control input 210. This aspect of the invention will now be explained.

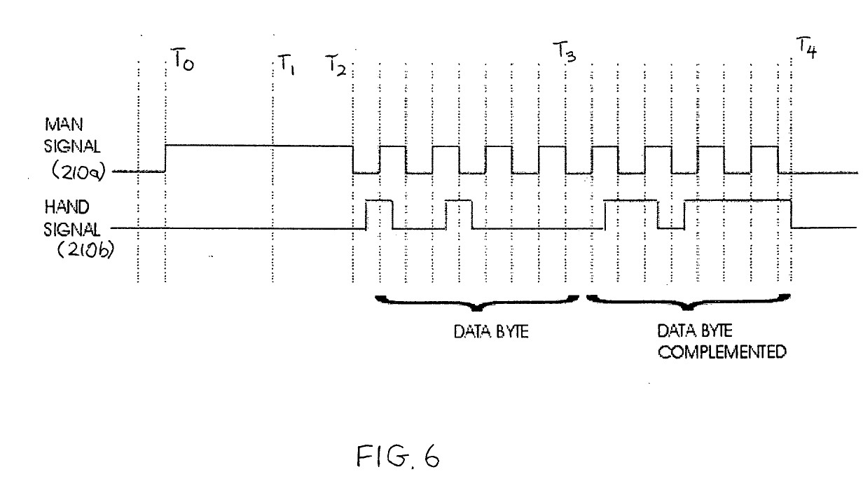

FIG. 6 depicts exemplary man signals and hand signals (as received at the microcontroller 216) when the countdown signal device 204 is in the programming mode. As will be explained, a traffic light unit programmer 400 is connected to the signal control input 210 of the countdown signal device 204 to provide the requisite man and hand signals to program the countdown signal device 204. As above, the actual program signals produced by the traffic light unit programmer 400 (and received on the man input 210a and the hand input 210b) are sinusoids, each approximately 117 Vrms. However, the opto-isolator section 214 converts these signals to the man logic signals and hand logic signals for use by the microcontroller 216.

Although the performance of the countdown signal device 204 will be discussed in association with the pedestrian signal device 202′, it should be understood that the countdown signal device 204 will perform in a similar manner when used in association with the traffic signal device 202.

Initially, power is removed from the signal control input 210 of the countdown signal device 204 for a period of time sufficient to reset the countdown signal device 204. Then power is reapplied to the signal control input 210 of the countdown signal device 204. At this time, the hand and man signals are both at the logic low level.

A program initialization interval begins (T0) when the man signal transitions to the logic high level. The initialization period ends (T1) if the man signal and the hand signal are maintained at their respective logic levels for a predetermined minimum period (eg. 1 s). The initialization interval provides the logic module 212 with sufficient time to allow the signals in the logic module 212 to stabilize.

The logic module 212 enters the programming mode if the man signal and the hand signal are maintained at their respective logic levels for a predetermined period (eg. 0.75 s) after the end of the initialization interval.

At the beginning of the programming cycle (T2), the man signal cycles between the logic high and logic low levels at 2 Hz. The programming command is received serially over the hand input 210b, least significant bit (LSB) first. As shown, the logic level of the hand signal is sampled at each high-low and low-high transition of the man signal.

The program command can be clocked at a slightly higher or lower rate than 2 Hz. However, at 2 Hz, the clock rate is low enough to allow the program command to be clocked over the hand input 210b without encountering bandwidth limitations imposed by the signal control input 210 and the opto-isolator section 214. Also, at 2 Hz, the clock rate is high enough that programming mode cannot be inadvertently initiated by the intersection traffic controller 300.

Preferably, the programming command is 8 bits in length. After the 8 bits of the programming command have been received (T3), preferably the complement of the programming command is received serially over the hand input 210b, LSB first. Other configurations of the programming command are intended to be encompassed by the present invention. For instance, the length of the programming command may be less than or greater than 8 bits; the programming command may be received MSB first.

The programming cycle terminates (T4) when the man signal remains at the logic low level. By this point, the logic module 212 will have received 16 transitions of the man signal (corresponding to the time required to receive 16 program bits over the hand input 210b).

At the end of the programming cycle, the logic module 212 compares the two bytes that it received over the hand input 210b. If the first byte received matches the complement of the second byte received, the logic module 212 concludes that a valid programming command was received, and alters the configuration/operation of the countdown signal device 204 (and the traffic signal produced by the countdown signal device 204) in accordance with the received programming command.

On the other hand, if the first byte received does not match the complement of the second byte received, the logic module 212 ignores the programming command and maintains the current configuration of the countdown signal device 204. Regardless of the validity of the programming command, the logic module 212 enters the normal operational mode after the two bytes have been compared. Other means for validating the programming command are intended to be encompassed by the present invention.

Preferably, the logic module 212 is configured to recognize one or more of the following programming commands: global time, walk count display, countdown maintain, flashing walk, time variation, lamp brightness, and brightness mode. The logic module 212 may be configured to implement other programming commands.

The global time command can require the logic module 212 to begin counting down at the countdown display 208 at the start of the pedestrian cycle and to continue counting throughout the pedestrian period. Thus, assuming a pedestrian cycle of 18 seconds, with a walk time of 10 second and a clearance time of 8 seconds, in this variation the countdown display 208 will begin counting at the start of the walk period with a count of 18, and will continue counting until the end of the clearance period.

Alternately, the global time command can require the logic module 212 to begin counting down at the start of the walk period, and to begin counting again at the start of the clearance period. Thus, assuming a pedestrian cycle of 18 seconds, with a walk time of 10 second and a clearance time of 8 seconds, in this variation the countdown display 208 will begin counting at the start of the walk period with a count of 10, and will begin counting again at the start of the clearance period with a count of 8.

The walk count display command can require the logic module 212 to display the count value during the walk period and the clearance period. Alternately, the walk count display command can require the logic module 212 to display the count value only during the clearance period.

The countdown maintain command requires the logic module 212 to maintain or remove the time indication at the countdown display 208 at the end of the clearance period. Typically, the time indication will be a zero count. However, if the length of the current pedestrian interval is shorter than the length of the previous pedestrian interval, the time indication at the end of the clearance period will be non-zero. The countdown maintain command can require the logic module 212 to maintain the count value at the countdown display 208 at the end of the clearance period, or may require the logic module 212 to remove the count value from the countdown display 208 at the end of the clearance period.

The flashing walk command can configure the logic module 212 to treat a “flashing walk” signal at the pedestrian signal device 202′ as a clearance signal. Alternately, the flashing walk command can configure the logic module 212 to treat a “flashing hand” signal at the pedestrian signal device 202′ as a clearance signal.

The time variation command can require the logic module 212 to ignore or recognize an incremental change (eg/ +/−1 s) in the duration of the pedestrian cycle. With this command, if the length of the current pedestrian cycle differs from the length of the previous pedestrian cycle by less than +/−1 s, the logic module 212 will not update the value of the walk counter and/or the clearance counter based on the length of the new pedestrian cycle, but will instead continue to use the previous values of the walk and clearance counters. This option is advantageous if the length of the pedestrian cycle is likely to change from cycle to cycle.

The lamp brightness command requires the logic module 212 to control the brightness of the traffic signal in accordance with the lamp brightness command. With this option, typically the logic module 212 is required to set the brightness of the traffic signal at night to a value specified by the lamp brightness command. The logic module 212 may also be required to set the brightness of the traffic signal at daylight to a value specified by the lamp brightness command.

The brightness mode command requires the logic module 212 to either set the brightness of the traffic signal to a maximum value, or to use a photocell to automatically adjust the brightness of the traffic signal based on a measure of the ambient light at the traffic light unit.

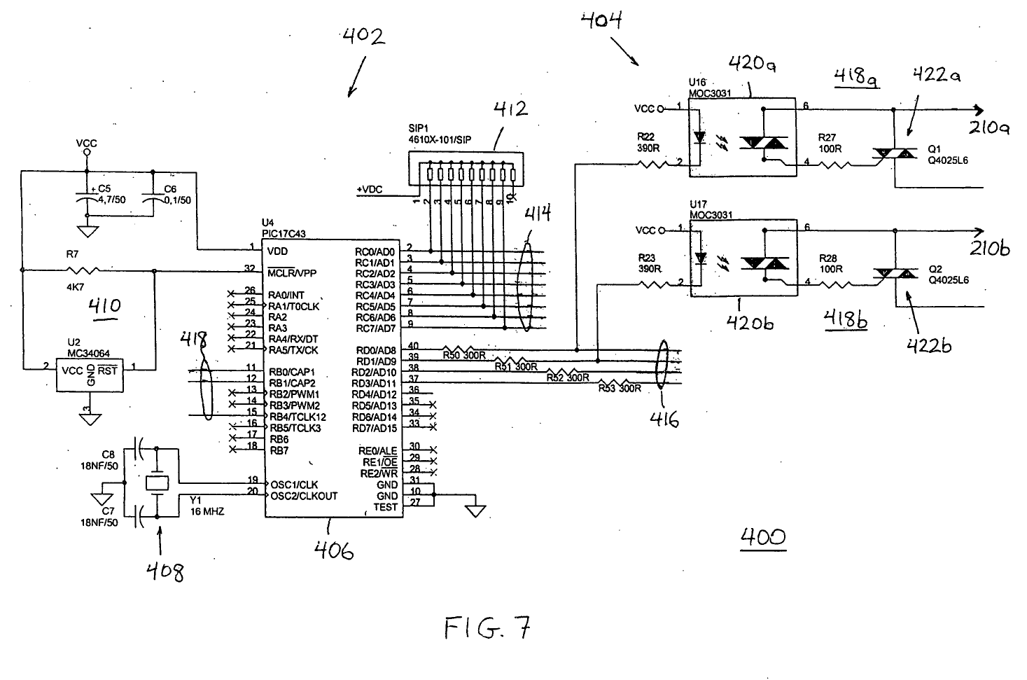

FIG. 7 depicts an embodiment of a traffic light unit programmer 400 which can be used to generate the programming commands for programming the countdown signal device 204. As will become apparent, to the extent that the aforementioned functionality of the countdown signal device 204 is reproduced in the traffic signal devices 202 and/or the pedestrian signal devices 202′, the traffic light unit programmer 400 can also be used to generate the programming commands for programming the traffic signal devices 202 and the pedestrian signal devices 202′.

As shown, the traffic light unit programmer 400 comprises a program module 402, and a traffic signal output section 404 coupled to the program module 402. The program module 402 comprises a microcontroller 406, an external oscillator section 408, a low-voltage reset section 410, and a pull-up resistor bank 412. The microcontroller 406 includes a program option digital input bus 414, a digital output bus 416, a program control digital input bus 418, and an embedded non-volatile memory.

The program option bus 414 is connected to the pull-up resistor bank 412, and an option switch array (not shown) that is used to select the desired signal configuration for the pedestrian signal. Some proposed signal configurations were discussed above with reference to FIG. 6. The program control bus 418 is connected to a program switch array (not shown) that is used to initiate programming of the countdown display 208.

The embedded non-volatile memory includes computer processing instructions which when executed by the microcontroller 406 configures the program module 402 to read the state of the option switch array, and based on the state of the option switch array, to transmit over the output bus 416 the signal sequence to configure the traffic signal. The desired signal sequence was discussed above with reference to FIG. 6.

The output bus 416 is connected to the input of the traffic signal output section 404 to thereby provide the traffic signal output section 404 with the signal sequence required to program the countdown signal device 204. The output of the traffic signal output section 404 interfaces with the signal control input 210 of the countdown signal device 204 to thereby transmit to the countdown signal device 204 the programming commands required to configure the traffic signal.

The traffic signal output section 404 includes a man (walk) output 418a a for connection to the man input 210a of the countdown signal device 204, and a hand (don't walk) output 418b for connection to the hand input 210b of the countdown signal device 204. As shown, the man output 418a comprises an opto-isolator 420a driven by a digital output of the digital output bus 416, and a triac 422a coupled to the output of the opto-isolator 420a.

Similarly, the hand output 418b comprises an opto-isolator 420b driven by a digital output of the digital output bus 416, and a triac 422b coupled to the output of the opto-isolator 420b. Both triacs 422 are powered by a 117 Vrms AC voltage source, to thereby provide the countdown signal device 204 with the 117 Vrms man signal and the 117 Vrms hand signal at the signal control input 210.

Other implementations of the program module 402 and the traffic signal output section 404 are intended to be encompassed by the present invention. For instance, instead of implementing the program module 402 with a microcontroller 406, the program module 402 may be implemented with an application specific integrated circuit (ASIC).

In normal operation, the signal control input 210 of each countdown signal device 204 is connected to the intersection traffic controller 300 and receives from the intersection traffic controller 300 the control signals described with reference to FIG. 5. As discussed above, the countdown signal device 204 generates the appropriate traffic signal (countdown signal), based on the control signals that it receives from the intersection traffic controller 300 and the configuration of the traffic signal that was programmed into the countdown signal device 204.

If it is desired to subsequently change the configuration of the traffic signal produced by one of the countdown signal devices 204, the technician removes power from the countdown signal device 204 by disconnecting the signal control input 210 of the countdown signal device 204 from the intersection traffic controller 300. The technician then connects the signal control input 210 of the countdown signal device 204 to the traffic signal output section 404 of the traffic light unit programmer 400.

The technician selects the desired traffic signal configuration from the option switch array. After allowing sufficient time for the countdown signal device 204 to reset, the technician commands the traffic light unit programmer 400 to initiate programming of the countdown signal device 204 by selecting the appropriate switch from the program switch array. The traffic light unit programmer 400 then applies power to the signal control input 210 of the countdown signal device 204 from the traffic light unit programmer 400.

Initially, the hand and man signals produced by the traffic light unit programmer 400 are both at the logic low level. However, shortly thereafter, the traffic light unit programmer 400 transitions the man signal at the man output 418a to the logic high level, thereby initializing the countdown signal device 204.

The traffic light unit programmer 400 maintains the hand and man signals at their respective levels for a predetermined minimum period (eg. 1.75 s) to provide the logic module 212 with sufficient time to allow the signals in the logic module 212 to stabilize, and to allow the countdown signal device 204 to enter the programming mode.

The traffic light unit programmer 400 then cycles the man signal at the man output 418a between the logic high and logic low levels at 2 Hz, and begins to transmit the programming command serially over the hand output 418b, least significant bit (LSB) first.

As discussed above, preferably the programming command is 8 bits in length. After the traffic light unit programmer 400 transmits all 8 bits of the programming command over the hand output 418b, preferably the traffic light unit programmer 400 transmits the complement of the programming command over the hand output 418b, LSB first. As mentioned above, other configurations of the programming command are intended to be encompassed by the present invention. For instance, the length of the programming command may be less than or greater than 8 bits; the programming command may be received MSB first.

After the traffic light unit programmer 400 has finished transmitting all 8 bits of the complement of the programming command, the traffic light unit programmer 400 stops cycling the man signal, and instead maintains the man signal at the man output 418a at the logic low level.

If the first byte of the programming sequence that was received at the logic module 212 of the countdown signal device 204 matches the complement of the second byte of the programming sequence, the logic module 212 concludes that a valid programming command was received, and alters the configuration/operation of the countdown signal device 204 in accordance with the received programming command. Preferably, the logic module 212 also generates a suitable signal on the countdown display 208 to confirm to the technician that the pedestrian traffic signal has been configured as desired. As mentioned above, other means for validating the programming command are intended to be encompassed by the present invention.

Once the pedestrian traffic signal of the countdown display 208 has been successfully reconfigured, the technician removes power from the countdown signal device 204 by disconnecting the signal control input 210 of the countdown signal device 204 from the traffic signal output section 404 of the traffic light unit programmer 400. The technician then reconnects the signal control input 210 of the countdown signal device 204 to the intersection traffic controller 300.

The intersection traffic controller 300 continues to generate the same control signals as before. However, the countdown signal device 204 generates the new configuration of the traffic signal, based on the control signals that it receives from the intersection traffic controller 300 and the new configuration of the traffic signal.

The foregoing description is intended to be illustrative of a preferred embodiment of the invention. Persons of ordinary skill in the art may envisage certain modifications to the described embodiment which, although not explicitly suggested herein, do not depart from the scope of the invention, as defined by the appended claims.

I claim:

1. A programmable traffic light unit comprising:
traffic signal means for producing a traffic signal;
a signal control input for receiving a control signal from an intersection traffic controller, the control signal being configured to control a timing of the traffic signal; and
a logic module coupled to the traffic signal means and the signal control input for controlling the traffic signal, the logic module being configured to configure the traffic signal from a programming command received over the signal control input.

2. The traffic light unit according to claim 1, wherein the traffic signal comprises a traffic display for controlling one of vehicular and pedestrian traffic, and a countdown display for indicating a time remaining before a change in status of the traffic display.

3. The traffic light unit according to claim 2, wherein the programming command comprises a countdown maintain command, and the traffic signal configuration comprises maintaining the time indication at the countdown display at the end of a clearance period, in accordance with the countdown maintain command.

4. The traffic light unit according to claim 3, wherein the programming command comprises a count display command, and the traffic signal configuration comprises counting down at the countdown display at the start of a pedestrian cycle, in accordance with the count display command.

5. The traffic light unit according to claim 4, wherein the programming command comprises a time extension command, the traffic signal comprising a don't walk signal, and the traffic signal configuration comprises maintaining the don't walk signal at the traffic display for a predetermined period after the end of the clearance period.

6. The traffic light unit according to claim 5, wherein the programming command comprises a time variation command, and the traffic signal configuration comprises ignoring a change in a duration of a pedestrian cycle, in accordance with the time variation command.

7. The traffic light unit according to claim 6, wherein the programming command comprises a flashing walk command, and the traffic signal configuration comprises treating one of a flashing walk signal and a flashing hand signal as a clearance signal, in accordance with the flashing walk command.

8. The traffic light unit according to claim 7, wherein the programming command comprises a lamp brightness command, and the traffic signal configuration comprises controlling a brightness of the traffic signal in accordance with the lamp brightness command.

9. The traffic light unit according to claim 8, wherein the programming command comprises a brightness threshold command, and the traffic signal configuration comprises adjusting the brightness of the traffic signal between an upper value and a lower value in accordance with the lamp brightness command and a measure of ambient light at the traffic light unit.

10. The traffic light unit according to claim 9, wherein the logic module is configured to recognize the programming command during a power-up interval of the traffic light unit, and to ignore the programming command after the power-up interval.

11. The traffic light unit according to claim 10, wherein the logic module is configured to ignore the control signal during the power-up interval, and to recognize the control signal after the power-up interval.

12. A traffic light unit programmer comprising:
a traffic signal output for interfacing with a signal control input of a traffic light unit, the traffic light unit including means for producing a traffic signal, the signal control input being configured to receive a control signal from an intersection traffic controller for controlling a timing of the traffic signal; and
a program module coupled to the traffic signal output, the program module being configured to transmit a programming command to the traffic light unit for implementing a configuration of the traffic signal.

13. The traffic light unit programmer according to claim 12, wherein the traffic signal comprises a traffic display for controlling one of vehicular and pedestrian traffic, and a countdown display for indicating a time remaining before a change in status of the traffic display.

14. The traffic light unit programmer according to claim 13, wherein the programming command comprises a countdown maintain command, and the traffic signal configuration comprises maintaining the time indication at the countdown display at the end of a clearance period, in accordance with the countdown maintain command.

15. The traffic light unit programmer according to claim 14, wherein the programming command comprises a count display command, and the traffic signal configuration comprises counting down at the countdown display at the start of a pedestrian cycle, in accordance with the count display command.

16. The traffic light unit programmer according to claim 15, wherein the programming command comprises a time extension command, the traffic signal comprising a don't walk signal, and the traffic signal configuration comprises maintaining the don't walk signal at the traffic signal device for a predetermined period after the end of the clearance period.

17. The traffic light unit programmer according to claim 16, wherein the programming command comprises a time variation command, and the traffic signal configuration comprises ignoring a change in a duration of a pedestrian cycle, in accordance with the time variation command.

18. The traffic light unit programmer according to claim 17, wherein the programming command comprises a flashing walk command, and the traffic signal configuration comprises treating one of a flashing walk signal and a flashing hand signal as a clearance signal, in accordance with the flashing walk command.

19. The traffic light unit programmer according to claim 18, wherein the programming command comprises a lamp brightness command, and the traffic signal configuration comprises controlling a brightness of the traffic signal in accordance with the lamp brightness command.

20. The traffic light unit programmer according to claim 19, wherein the programming command comprises a brightness threshold command, and the traffic signal configuration comprises adjusting the brightness of the traffic signal between an upper value and a lower value in accordance with the lamp brightness command and a measure of ambient light at the traffic light unit.

21. A method of programming a traffic light unit, the traffic light unit comprising traffic signal means for producing a traffic signal and a signal control input for receiving a control signal from an intersection traffic controller, the control signal being configured to control a timing of the traffic signal, the method comprising the steps of:
directing the traffic light unit into a programming mode;
transmitting a program command to the traffic light unit via the signal control input; and
directing the traffic light unit into a normal operational mode.

22. The method according to claim 21, wherein the signal control input comprises a first signal input for generating a first traffic signal for initiating traffic flow through an intersection, and a second signal input for generating a second traffic signal for terminating the traffic flow, and the step of transmitting the program command comprises transmitting the program command over one of the first and second signal inputs.

23. The method according to claim 22, wherein the step of transmitting the program command comprises applying a clock signal to one of the first and second signal inputs while applying the program command to the other of the first and second signal inputs.

24. The method according to claim 23, wherein the step of transmitting the program command comprises applying a clock signal to the first signal input, and applying the program command to the second signal input.

25. The method according to claim 24, wherein the step of transmitting the program command comprises applying the program command serially to the second signal input.

26. The method according to claim 25, wherein the step of directing the traffic light unit into a programming mode comprises the steps of resetting the traffic light unit while applying a program initiation command to the signal control input.

27. The method according to claim 26, wherein the step of resetting the traffic light unit comprises momentarily removing power from the traffic light unit.

28. A computer-readable medium carrying processing instructions for a computer which, when executed, cause the computer to perform a method of programming a traffic light unit, the traffic light unit comprising traffic signal means for producing a traffic signal and a signal control input for receiving a control signal from an intersection traffic controller, the control signal being configured to control a timing of the traffic signal, the programming method comprising transmitting a program command to the traffic light unit via the signal control input.

29. The computer-readable medium according to claim 28, wherein the signal control input comprises a first signal input for generating a first traffic signal for initiating traffic flow through an intersection, and a second signal input for generating a second traffic signal for terminating the traffic flow, and the step of transmitting the program command comprises transmitting the program command over one of the first and second signal inputs.

30. The computer-readable medium according to claim 29, wherein the step of transmitting the program command comprises applying a clock signal to one of the first and second signal inputs while applying the program command to the other of the first and second signal inputs.

31. The computer-readable medium according to claim 30, wherein the step of transmitting the program command comprises applying a clock signal to the first signal input while applying the program command to the second signal input.

32. The computer-readable medium according to claim 31, wherein the step of transmitting the program command comprises applying the program command serially to the second signal input.
